(19) United States
(12) Patent Application Publication
(10) Pub. No.: US 2010/0032142 A1
(43) Pub. Date: Feb. 11, 2010

(54) LIQUID COOLED RACK WITH OPTIMIZED AIR FLOW RATE AND LIQUID COOLANT FLOW

(75) Inventors: David W. Copeland, Mountain View, CA (US); Marlin R. Vogel, Fremont, CA (US); Andrew R. Masto, San Jose, CA (US)

Correspondence Address: OSHA LIANG L.L.P./SUN, TWO HOUSTON CENTER, 909 FANNIN, SUITE 3500, HOUSTON, TX, 77010, US

(73) Assignee: SUN MICROSYSTEMS, INC., Santa Clara, CA (US)

(21) Appl. No.: 12/189,577

(22) Filed: Aug. 11, 2008

(51) Int. Cl. F28D 15/00; G05D 23/00; G05D 7/00

(52) U.S. Cl. 165/104.33; 165/104.31; 165/293; 700/282

(57) ABSTRACT

A cooling system for a rack-mount server including at least one blade includes a liquid cooling line, a pump connected to the liquid cooling line, at least one heat exchanger connected to the liquid cooling line, a fan module, a control module connected to the fan module and the pump, a feedback module connected to the control module and comprising a sensor configured to measure a feedback control signal, where the control module is configured to adjust an air flow rate through the fan module or a liquid coolant flow rate through the pump based on the feedback control signal.

### BACKGROUND OF INVENTION

Modern rack-mount server systems include single and multiple liquid heat exchangers that cool air through a rack-mount server system to enable the deployment of high density electronic modules (“blades”) within the system. The rack-mount server systems may further comprise fans configured to blow air through the server and the heat exchangers. The overall cooling capacity of a server system may be affected by both the air flow rate of the fans and the liquid coolant flow rate through the heat exchangers. Accordingly, there is a tradeoff between power supplied to a fan blower system and power supplied to a liquid coolant pumping system with respect to the overall cooling capacity of the server system.

### SUMMARY OF THE INVENTION

A cooling system for a rack-mount server including at least one blade and a system enclosure is disclosed herein. The cooling system includes a liquid cooling line, a pump connected to the liquid cooling line, at least one heat exchanger connected to the liquid cooling line, a fan module, a control module connected to the fan module and the pump, and a feedback module connected to the control module and comprising a sensor configured to measure a feedback control signal, where the control module is configured to adjust an air flow rate through the fan module or a liquid coolant flow rate through the pump based on the feedback control signal.

A method of controlling the power consumption of a cooling system for a rack-mount server including at least one blade, a pump, a fan module, at least one heat exchanger, and a liquid cooling line is disclosed herein. The method includes connecting a control module to the pump and the fan module, measuring a feedback control signal with a feedback module comprising a sensor and connected to the control module, and adjusting a liquid coolant flow rate through the pump or an air flow rate through the fan module with the control module based on the feedback control signal.

### BRIEF DESCRIPTION OF DRAWINGS

FIG. 1 shows a block diagram of a cooling server system in accordance with embodiments disclosed herein.

FIG. 2 shows a block diagram of a control loop in accordance with embodiments disclosed herein.

FIG. 3 shows a method of controlling power consumption of a cooling system in accordance with embodiments disclosed herein.

FIG. 4 shows a computer system in accordance with embodiments disclosed herein.

### DETAILED DESCRIPTION

Specific details of the present disclosure will now be described in detail with reference to the accompanying figures.

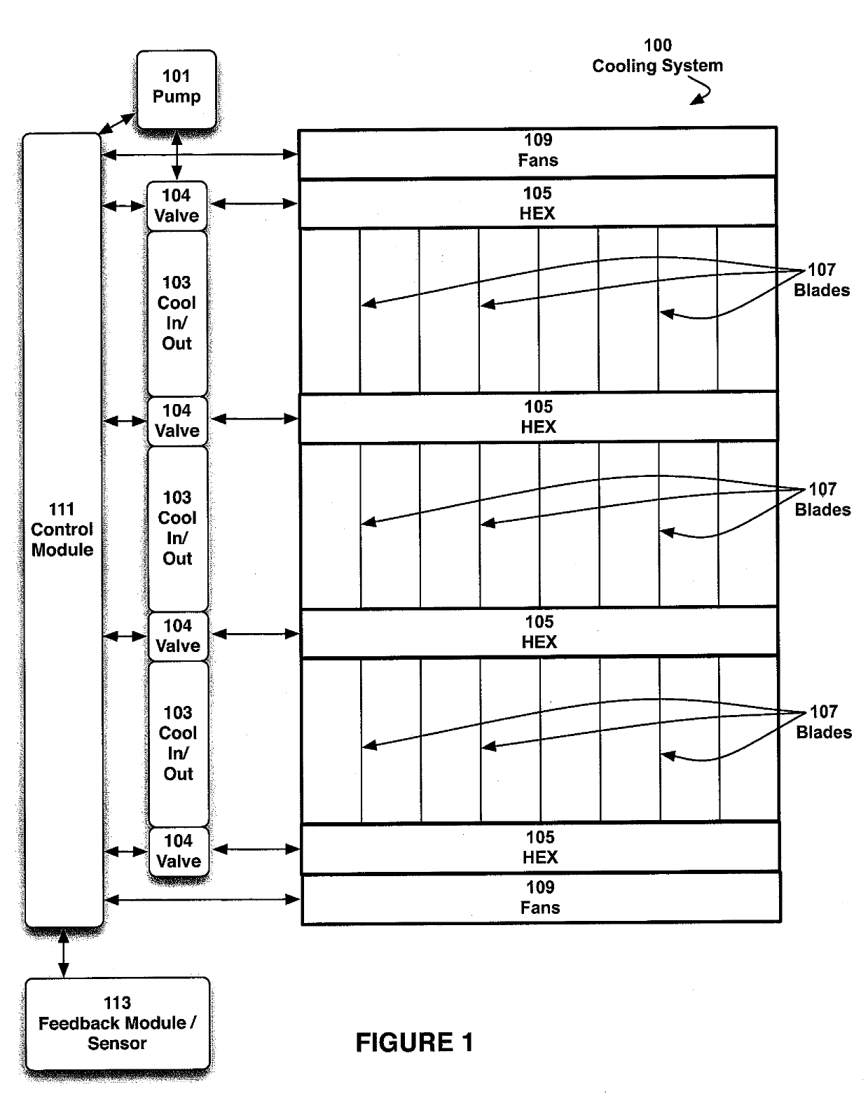

Referring now to FIG. 1, a front view of a cooling system for a rack-mount server in accordance with embodiments disclosed herein is shown. The cooling system 100 includes a pump 101, a cooling intake/outtake line 103, a plurality of valves 104, a plurality of heat exchangers (“HEX”) 105, a plurality of blades, or electronic components, 107, and a plurality of fans 109 in accordance with embodiments disclosed herein. The fans 109 are configured at the top and bottom of the rack-mount server to blow air through the heat exchangers 105 in order to cool the blades 107. The blades 107 are divided into different racks, and there at least one heat exchanger 105 corresponding to each of the different racks. Each heat exchanger 105 is configured to take in cooled liquid from the cooling intake/outtake line 103 through an adjustable valve 104, chill air flowing across the heat exchanger 105, and return warmed liquid through the valve 104 to the cooling intake/outtake line 103. The pump 101 may maintain pressure on a liquid coolant flowing through the cooling intake/outtake line 103.

The cooling capacity of each heat exchanger 105 in the cooling system 100 is proportional to both the liquid coolant flow rate of a liquid coolant through the heat exchanger 105 and the air flow rate of air through the fans 109. If the temperature of the entire rack-mount server system needs to be reduced, power may be increased to either the fans 109 or the pump 101 in order to decrease the temperature. These two methods may require different amounts of power for a specific change in temperature.

Accordingly, it may be desirable to determine the path to a specific temperature that minimizes total power consumption of the cooling system 100.

In order to minimize total power consumption, the cooling system 100 further includes a control module 111 and a feedback module 113 that may include a sensor.

The control module 111 may be connected to the pump 101, the valves 104, and the fans 109. The control module 111 may be configured to receive a feedback control signal from the sensor in the feedback module 113 and adjust the power to the pump 101 in order to adjust the flow rate of the liquid coolant through the cooling intake/outtake line 103 or adjust the power to the fans 109 in order to adjust the air flow rate through the fans. The control module 111 may be further configured to determine the least costly path to a specific temperature based on the feedback control signal and a desired temperature. The desired temperature may be, for example, the temperature at which the rack-mount server system is in thermodynamic equilibrium with the ambient room temperature. In order to reach a desired temperature, the control module 111 may determine to adjust one or both of the air flow rate through the fans 109 and the liquid coolant flow rate through the pump 101.

Alternatively, valves 104 may be installed between the heat exchangers 105 and the cooling intake/outtake line 103 in order to adjust the cooling flow on a per heat exchanger basis. Each of the valves 104 may be connected to the control module 111, and the control module 111 may control the flow rate of liquid coolant through each of the valves 104 in order to adjust the power consumption of the pump 101. Advantageously, this arrangement allows the total power used by the pump 101 to be reduced when less cooling capacity is required in the cooling system 100.

The control module 111 may be any module capable of receiving a sensor measurement, determining an appropriate coolant flow rate or an appropriate air flow rate, and outputting control signals to the pump 101, the fans 109, and the valves 104. For example, the pump 101, fans 109, and adjustable valves 104 may be electronically controlled, and the control signal may be an electric signal transmitted from the control module 111. Examples of the control module 111 include hardware modules such as field-programmable gate arrays and software modules. The feedback module 113 may be any module capable of receiving one or more sensor readings and transmitting one or more feedback control signals to the control module 111 and may include a sensor to measure the feedback control signal from portions of the rack server. The sensor may be, for example, a temperature sensor configured to measure the temperature of one or more of the plurality of blades 107. In this case, the feedback control signal would be a temperature measurement from the temperature sensor.

Alternatively, the sensor may be, for example, a power consumption sensor configured to measure the power consumption of one or more of the plurality of blades 107. In this case, the feedback control signal would be a power consumption measurement from the power consumption sensor. Finally, the sensor may be, for example, a thermodynamic sensor configured to measure the heat flow per cubic unit through the intake and outtake lines of the cooling intake/outtake line 103 or through the exhaust of the fans 109. The heat flow through the outtake line or the fan exhaust is proportional to the total cooling capacity of the system. If, for example, the liquid flowing through the outtake line or the air flowing through the fan exhaust is cooler than necessary, the valves 104 or the fans 109 may be adjusted to reduce the total liquid coolant flow rate through the cooling system 100. In this case, the feedback control signal would be a thermodynamic sensor measurement from the thermodynamic sensor. A second temperature or thermodynamic sensor may also be disposed in the feedback module 113 in order to measure the temperature of inlet air to the fans. The measurement from the second sensor may be transmitted as a second feedback control signal to the control module 111 to determine necessary adjustments in the cooling capacity of the cooling system 100.

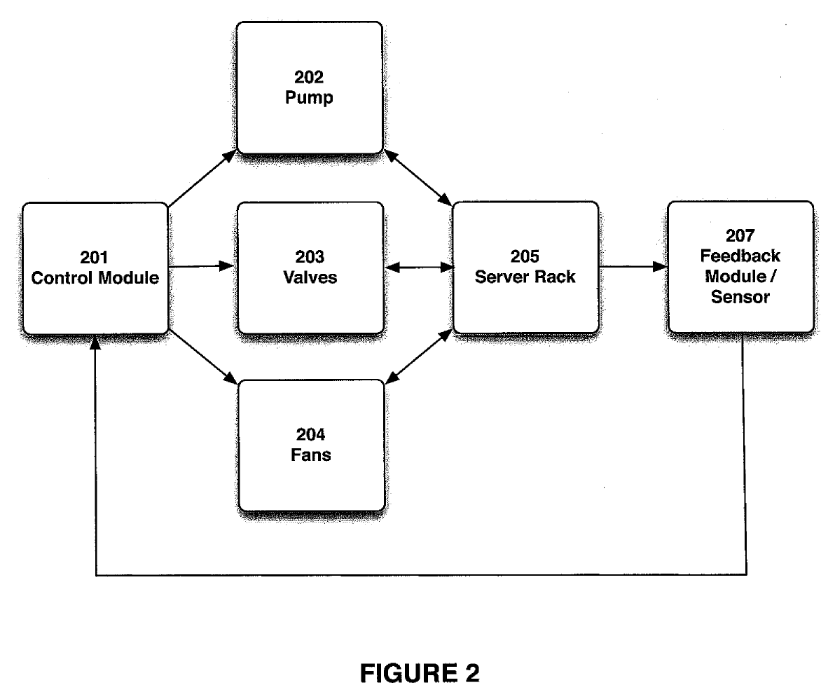

Referring now to FIG. 2, a block diagram of a control loop in accordance with embodiments disclosed herein is shown. A control module 201 is connected in parallel to each of a pump 202, a system of valves 203, and fans 204. The pump 202 and the system of valves 203 each connect via a liquid coolant line (not shown) to a server rack 205. The fans 204 are directly blowing air over the server rack 205. A feedback control module 207 including a sensor is connected directly to the server rack 205, and also connected back to the control module 201 to return a feedback control signal based on one or more sensor readings from the server rack. In this example, the sensor may be either a temperature or power consumption sensor discussed above with respect to FIG. 1. In alternate embodiments, the sensor may be a thermodynamic sensor connected to either any of the pump 202, the system of valves 203, or the fans 204.

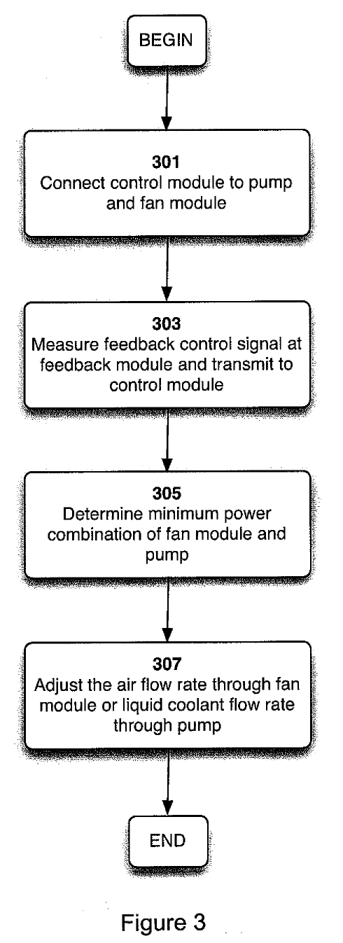

Referring now to FIG. 3, a method of controlling the power consumption of a cooling system for a rack-mount server including at least one blade, at least one heat exchanger, and a liquid cooling line in accordance with embodiments disclosed herein is shown. First, in step 301, a control module is connected to both a pump and fan module or plurality of fans. The control module may also be connected to a system of valves disposed between the liquid cooling line and the at least one heat exchanger. Next, in step 303, a feedback control signal is measured by a sensor disposed in a feedback module that is also connected to the control module in order to transmit the feedback control signal to the control module. The feedback control module may also transmit the feedback control signal to the control module in step 303.

Upon receiving the feedback control signal, in step 305, the control module may determine the minimum power necessary to reach a desired temperature within the rack-mount server. The control module may consider, for example, adjusting the power to the fans or the pump in order to reach the desired temperature. Alternatively, the control module may also consider adjusting the system of valves.

Based on thermodynamic properties of each of the pump, fans, and valves the control module may calculate the total change in power necessary for each of the pump, fans, and valves to reach the desired temperature. The control module may then determine the minimum change power necessary in one or more of the pump, fans, and valves to reach the desired temperature. For example, adjusting the power to only the fans may result in the least expensive path to the desired temperature by increasing the air flow rate through the rack-mount server. Alternatively, both the liquid coolant flow rate and the air flow rate through the rack-mount server may be adjusted.

Finally, in step 307, the control module adjusts the air flow rate or the liquid coolant flow rate through the rack-mount server in order to adjust the cooling capacity of the cooling system and change the temperature of the rack-mount server. The control module may also adjust the valves disposed between the heat exchangers and the liquid cooling line. Advantageously, this method allows the control module to determine the cheapest method among the pump, fans, and valves of cooling the rack-mount server from a power perspective. Alternatively, the control module may use a similar procedure to determine the greatest power savings in reducing power to the pump, fans, and/or valves, if the rack-mount server is cooler than necessary.

In a specific example comparing the use of increased air flow (fan power) versus increased coolant flowrate (pump power) to reduce CPU junction temperature (T,cpu,junction) through the use of a coolant-to-air heat exchanger located at the air intake inlet of the server, the below example shows that in order to reduce the CPU junction temperature by 0.7° C. through increased air flow rate, increased power supplied to the fan is 65.3 W (Watts). In comparison, decreasing the CPU junction temperature by 0.7° C. through increasing the coolant flow rate would require an increase of 59 W supplied to the coolant pump. Accordingly, in this example case, the power optimization algorithm would result in increasing the pump input power rather than increasing the fan input power.

The below example shows the different power costs associated with increasing the coolant flow rate or the air flow rate to produce the same degree of cooling in a system where:

ETA (heat exchanger air-side efficiency)=0.457 at V,air=2200 cfm (cubic feet per minute), V,coolant=7 gpm (gallons per minute) (1)

ETA=0.500 at V,air=2200 cfm, V,coolant=10 gpm (2)

T,coolant,in=18° C., T,air,in=35° C. (3)

Given that:

ETA,hex=(T,air,in−T,air,exit)/(T,air,in−T,coolant,in) (4)

which means,

T,air,exit=T,air,in−ETA×(T,air,in−T,coolant,in) (5)

By substituting the values of (1), (2), and (3) into (5),

T,air,exit=35° C.−0.457×(35° C.−18° C.)=27.23° C. (at V,coolant=7 gpm), and

T,air,exit=35° C.−0.500×(35° C.−18° C.)=26.5° C. (at V,coolant=10 gpm)

If, for example:

T,cpu,junction=90.45° C. (at V,air=2200 cfm, 7 gpm) (6)

T,cpu,junction=89.75° C. (At V,air=2200 cfm, 10 gpm) (7)

Then, the pump power required at V,coolant=7 gpm

dP,coolant=10 psi at 7 gpm (8)

dP,coolant=20.4 psi at 10 gpm (9)

With (10) pump efficiency=0.6

The hydraulic power required is:

P.hyd=(V,coolant)×(dP,coolant) (11)

Power,pump=(P,hyd)/(pump efficiency) (12)

Then, substituting the values (8) into (11)

P.hyd=7 gpm×10 psi=7×(gal/min)×(0.1337 ft̂3/gal)×(min/60 sec)×(10 lbf/in̂2)×(144 in̂2/ft̂2)=2.4 ft-lbf/sec=22.4 (ft-lbf/sec)×(1055 J/778 ft-lbf)=30.4 W (13)

Then, substituting the values of (10) and (13) into (12)

Power,pump=30.4 W/0.6=50.7 W at 7 gpm (14)

Then, substituting the values of (9) into (11)

P.hyd=10 gpm×20.4 psi=10×(gal/min)×(0.1337 ft̂3/gal)×(min/60 sec)×(20.4 lbf/in̂2)×(144 in̂2/ft̂2)=65.3 ft-lbf/sec=65.3 (ft-lbf/sec)×(1055 J/778 ft-lbf)=88.6 W (15)

Then, substituting the values of (10) and (15) into (12)

Power,pump=88.6 W/0.6=147.7 W at 10 gpm (16)

Thus, the increased pump power required to decrease T,cpu,junction from 90.45° C. to 89.75° C. is:

dPower,pump=147.7 W−88.6 W=59.1 W (17)

Alternatively, if an increase in fan power is used to decrease T,cpu,junction from 90.45° C. to 89.75° C., the power costs are determined by:

T,cpu,junction=90.45° C. at V,air=2200 cfm, V,coolant=7 gpm, dP,air=1.82″ H₂O (water) (18)

With (19) Fan efficiency=0.4

Power,fan=V,air×dP,air×0.117/fan efficiency (20)

Then, substituting the values of (18) and (19) into (20)

Power,fan=2200×1.81×0.117/0.4=1164.7 W at V,air=2237 cfm, V,coolant=7 gpm (21)

T,cpu,junction=89.75° C. at V,air=2200 cfm, V,coolant=10 gpm, at dP,air=1.88″ H₂O (22)

By substituting (19) and (21) into (20):

Power,fan=2237×1.88×0.117/0.4=1230 W (23)

Thus, the increased fan power required to decrease T,cpu,junction from 90.45° C. to 89.75° C. is:

dPower,fan=1230 W−1164.7 W=65.3 W

Accordingly, in view of the above example, it will be clear to one skilled in the art that given the various environmental variables, the power requirements for cooling a particular system by a particular amount using increased coolant flow rate and/or the air flow rate can be optimized to reduce the amount of power required to produce the required amount of cooling.

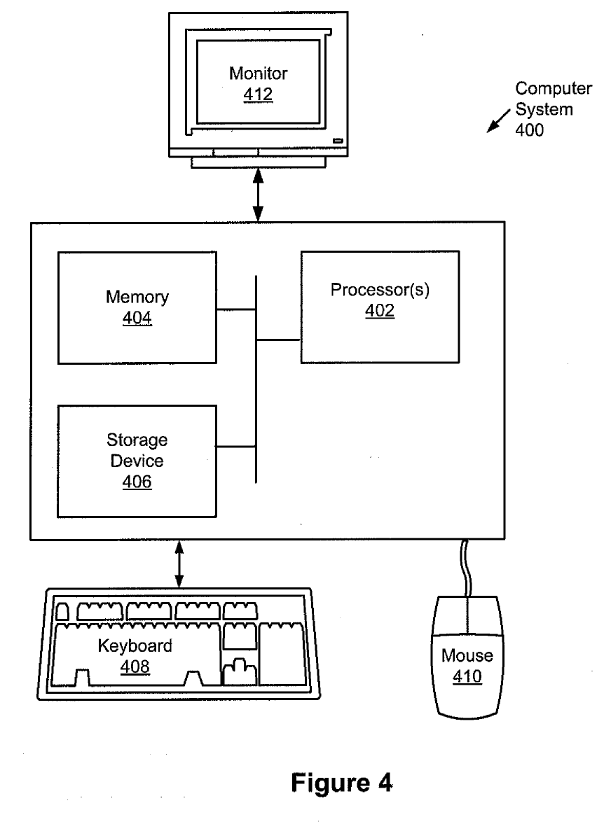

Referring now to FIG. 4, portions of the invention may be implemented in software, such as, for example, the control module and feedback module discussed above with respect to FIGS. 1 and 2. These portions of the invention may be implemented on virtually any type of computer regardless of the platform being used. For example, as shown in FIG. 4, a computer system 400 includes a processor 402, associated memory 404, a storage device 406, and numerous other elements and functionalities typical of today's computers (not shown). The computer system 400 may also include input means, such as a keyboard 408 and a mouse 410, and output means, such as a monitor 412. The computer system 400 is connected to a local area network (LAN) or a wide area network (e.g., the Internet) (not shown) via a network interface connection (not shown). Those skilled in the art will appreciate that these input and output means may take other forms, now known or later developed. Further, those skilled in the art will appreciate that one or more elements of the aforementioned computer system 400 may be located at a remote location and connected to the other elements over a network.

Further, portions of the invention may be implemented on a distributed system having a plurality of nodes, where each portion of the invention may be located on a different node within the distributed system. In one or more embodiments of the invention, the node corresponds to a computer system. Alternatively, the node may correspond to a processor with associated physical memory.

In one or more embodiments of the invention, software instructions to perform embodiments of the invention, when executed by a processor, may be stored on a computer readable medium such as a compact disc (CD), a diskette, a tape, a file, or any other computer readable storage device. Further, one or more embodiments of the invention may be implemented as an Application Program Interface (API) executing on a computer system(s), where the API includes one or more software instructions.

Embodiments of the cooling system disclosed herein may exhibit one or more of the following advantages. The cooling system disclosed herein may reduce costs for cooling a rack-mount server by reducing the pump power or fan power required for cooling the rack-mount server. The cooling system disclosed herein may also allow for cooling to be distributed according to the heat dissipation of blades or groups of blades in a rack-mount server.

While the invention has been described with respect to a limited number of embodiments, those skilled in the art, having benefit of this disclosure, will appreciate that other embodiments may be devised which do not depart from the scope of the invention as disclosed herein. Accordingly, the scope of the invention should be limited only by the attached claims.

What is claimed is:

1. A cooling system for a rack-mount server comprising at least one blade, comprising:
a liquid cooling line;
a pump connected to the liquid cooling line;
at least one heat exchanger connected to the liquid cooling line;
a fan module;
a control module connected to the fan module and the pump; and
a feedback module connected to the control module and comprising a sensor configured to measure a feedback control signal,
wherein the control module is configured to adjust an air flow rate through the fan module or a liquid coolant flow rate through the pump based on the feedback control signal.

2. The cooling system of claim 1, further comprising at least one adjustable valve connected between the at least one heat exchanger and the liquid cooling line.

3. The cooling system of claim 2, wherein the control module is further configured to adjust a liquid coolant flow rate through the at least one adjustable valve based on the feedback control signal.

4. The cooling system of claim 2, wherein the at least one adjustable valve comprises an electronically controlled valve.

5. The cooling system of claim 1, wherein the control module is further configured to adjust the air flow rate through the fan module or the liquid coolant flow rate through the pump based on a desired temperature.

6. The cooling system of claim 5, wherein the desired temperature is equal to an ambient room temperature surrounding the rack-mount server.

7. The cooling system of claim 1, wherein the sensor comprises a temperature sensor configured to measure a temperature of the at least one blade and generate the feedback control signal based on the measured temperature.

8. The cooling system of claim 1, wherein the sensor comprises a temperature sensor configured to measure a temperature of air exhaust from the rack-mount server and generate the feedback control signal based on the measured temperature.

9. The cooling system of claim 1, further comprising a second sensor configured to measure a temperature of inlet air to the rack-mount server and generate a second feedback control signal based on the measured temperature.

10. The cooling system of claim 1, wherein the sensor comprises a power consumption sensor configured to measure power consumption of the at least one blade and generate the feedback control signal based on the measured power consumption.

11. The cooling system of claim 1, wherein the sensor comprises a thermodynamic sensor configured to measure a thermodynamic state of a coolant in the liquid cooling line and generate the feedback control signal based on the measured thermodynamic state.

12. A method of controlling the power consumption of a cooling system for a rack-mount server comprising at least one blade, a pump, a fan module, at least one heat exchanger, and a liquid cooling line, the method comprising:
connecting a control module to the pump and the fan module;
measuring a feedback control signal with a feedback module comprising a sensor and connected to the control module; and
adjusting a liquid coolant flow rate through the pump or an air flow rate through the fan module with the control module based on the feedback control signal.

13. The method of claim 12, wherein the cooling system further comprises at least one adjustable valve connected between the at least one heat exchanger and the liquid cooling line.

14. The method of claim 13, further comprising adjusting a liquid coolant flow rate through the at least one adjustable valve with the control module based on the feedback control signal.

15. The method of claim 13, wherein the at least one adjustable valve comprises an electronically controlled valve.

16. The method of claim 12, further comprising determining a minimum total power supplied to the fan module and the pump necessary to cool the rack-mount server to a specific temperature.

17. The method of claim 12, wherein the sensor comprises a temperature sensor configured to measure the temperature of the at least one blade and generate the feedback control signal based on the measured temperature.

18. The method of claim 12, wherein the sensor comprises a power consumption sensor configured to measure the power consumption of the at least one blade and generate the feedback control signal based on the measured power consumption.

19. The method of claim 12, wherein the sensor comprises a thermodynamic sensor configured to measure the thermodynamic state of a coolant in the liquid cooling line and generate the feedback control signal based on the measured thermodynamic state.
